(19) United States
(12) Patent Application Publication
(10) Pub. No.: US 2015/0277698 A1
(43) Pub. Date: Oct. 1, 2015

(54) PROCESSING MULTI-TOUCH INPUT TO SELECT DISPLAYED OPTION

(71) Applicant: ABBYY Development LLC, Moscow (RU)

(72) Inventor: Aram Bengurovich Pakhchanian, Moscow (RU)

(21) Appl. No.: 14/571,932

(22) Filed: Dec. 16, 2014

(30) Foreign Application Priority Data
Mar. 31, 2014 (RU) 2014112239

(51) Int. Cl. G06F 3/0488

(52) U.S. Cl. CPC G06F 3/0488; G06F 2203/04104

(57) ABSTRACT

Systems and methods for processing multi-touch input to select a displayed option. An example method may comprise: presenting, on a display of a computing device, a plurality of alternative options pertaining to digital content; receiving, via a touch-sensitive input area of the display, a multi-touch gesture comprising one or more touch contacts with the touch-sensitive input area; and identifying an option having an ordinal position on the display, relative to positions of other alternative options, that corresponds to a number of touch contacts comprised by the received multi-touch gesture.

### CROSS REFERENCE TO RELATED APPLICATIONS

This application claims the benefit of priority to Russian Patent Application No. 2014112239, filed Mar. 31, 20114; disclosure of which is incorporated herein by reference in its entirety.

### TECHNICAL FIELD

The present disclosure is generally related to computing devices, and is more specifically related to systems and methods for processing multi-touch input.

### BACKGROUND

Various modern computing devices, including smart phones, tablet computers, and other mobile or desktop computing devices, may be equipped with multi-touch input interfaces (e.g., touch screens or track pads). The term “multi-touch” herein refers to the ability of a touch-sensitive surface to recognize multiple simultaneous (or nearly simultaneous) tactile contacts with the surface. Such multiple-contact awareness may be used to recognize various complex user interface gestures.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 depicts a block diagram of one embodiment of a computing device operating in accordance with one or more aspects of the present disclosure;

FIGS. 2A-2B schematically illustrate examples of the user interface presented by a touch-sensitive display of the computing device 100 of FIG. 1, in accordance with one or more aspects of the present disclosure;

FIG. 3 depicts a flow diagram of an illustrative example of a method for processing multi-touch input to select a displayed option, in accordance with one or more aspects of the present disclosure; and

FIG. 4 depicts a more detailed diagram of an illustrative example of a computing device implementing the methods described herein.

### DETAILED DESCRIPTION

Described herein are methods and systems for processing multi-touch input to select a displayed option presented on a screen of a computing device. “Computing device” herein shall refer to a data processing device having a general purpose processor, a memory, and at least one communication interface. Examples of computing devices that may employ the methods described herein include, without limitation, smart phones, tablet computers, notebook computers, wearable accessories, and various other mobile and stationary computing devices.

In an illustrative example, a computing device equipped with a touch screen may display text produced by optical character recognition (OCR) or intelligent character recognition (ICR) software, and may allow a user to provide input verifying specific sections of the text. In particular, the touch screen may display the text along with two or more alternative options (e.g., produced by OCR or ICR software) corresponding to a highlighted section of the text. The operator of the computing device may be prompted to select one of the displayed options. In conventional systems, the operator may be expected to indicate the selection by tapping the area of the touch screen where the selected option is displayed. Thus, the operator may be required to perform various hand, arm and/or shoulder movements to position his or her finger over the area to be tapped. Processing of large texts may thus put a significant physical strain onto the operator's hand, arm and/or shoulder, and lead to the muscle fatigue thus reducing the operator's productivity. The latter may be further adversely affected by a potentially high rate of positioning errors which is an inherent feature of various single-point touch input recognition methods. Furthermore, positioning the operator's finger over the screen area to be tapped may require the operator to visually control the hand movements which may lead to eye fatigue, thus further reducing the operator's productivity.

The present disclosure addresses the above noted and other deficiencies by minimizing the operator's bodily movements involved in selecting the desired option out of multiple displayed options. In certain implementations, the computing device operating in accordance with one or more aspects of the present disclosure may display a character string and multiple alternative substrings (e.g., produced by OCR or ICR software) representing a highlighted fragment (e.g., one or more characters) of the displayed character string. Visually associated with each option, a graphical representation of a multi-touch gesture that the user is required to perform for selecting the corresponding option may be displayed.

In certain implementations, each gesture may comprise a multi-touch tactile contact involving the number of operator's fingers being equal to the ordinal number (displayed or implicit) of the display position of the option to be selected. In an illustrative example, to select the option number one, a single-touch contact with a pre-defined input area of the touch screen may be required, to select the option number two, a two-finger contact with the input area of the touch screen may be required, and so on. For each displayed option, a graphical representation of a multi-touch gesture may visually instruct the operator on the number of tactile contact points required to select the option.

Responsive to receiving the operator's multi-touch gesture, the computing device may associate the highlighted substring with the displayed option having the ordinal position on the display, relative to positions of other alternative options, that corresponds to the number of touch contacts comprised by the multi-touch gesture, as described in more details herein below.

It should be noted that although aspects of the present disclosure are described with reference to text, the present disclosure is also applicable to other types of digital content such as images, graphics and so on. Various aspects of the above referenced methods and systems are described in details herein below by way of examples, rather than by way of limitation.

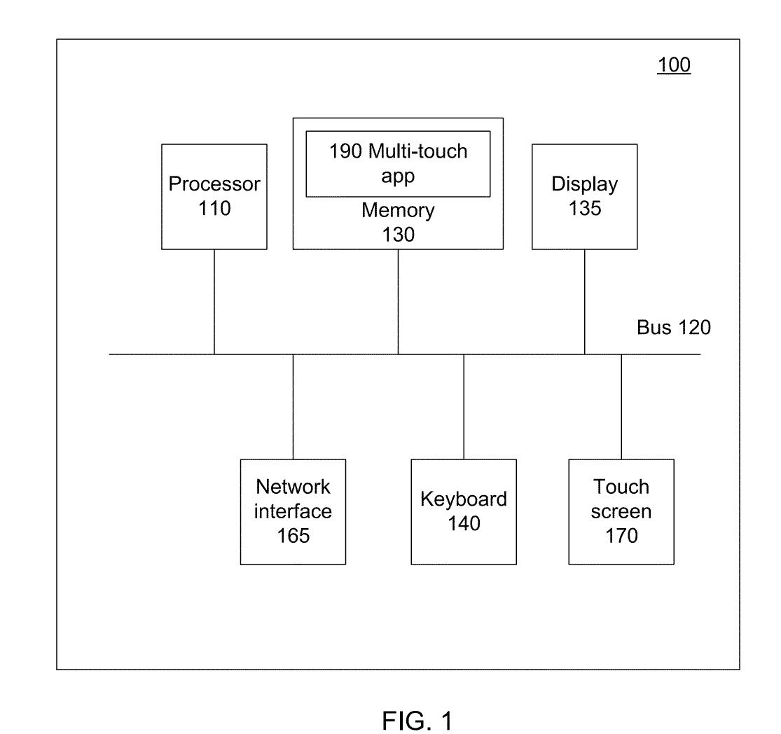

FIG. 1 depicts a block diagram of one illustrative example of a computing device 100 operating in accordance with one or more aspects of the present disclosure. In illustrative examples, computing device 100 may be provided by various computing devices including a tablet computer, a smart phone, a notebook computer, or a desktop computer.

Computing device 100 may comprise a processor 110 coupled to a system bus 120. Other devices coupled to system bus 120 may include memory 130, display 135 equipped with a touch screen input device 170, keyboard 140, and one or more communication interfaces 165. The term “coupled” herein shall include both electrically connected and communicatively coupled via one or more interface devices, adapters and the like.

Processor 110 may be provided by one or more processing devices including general purpose and/or specialized processors. Memory 130 may comprise one or more volatile memory devices (for example, RAM chips), one or more non-volatile memory devices (for example, ROM or EEPROM chips), and/or one or more storage memory devices (for example, optical or magnetic disks).

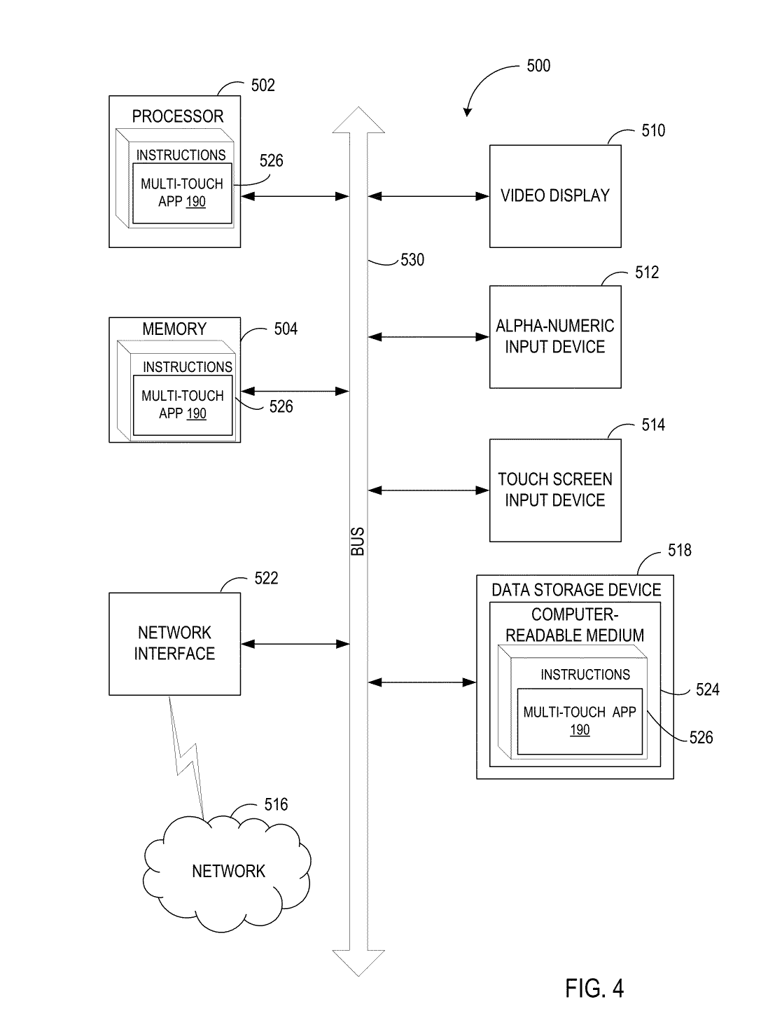

Touch screen input device 170 may be represented by a touch-sensitive input area and/or presence-sensitive surface overlaid over display 135. In an illustrative example, the touch-sensitive input area may comprise a capacity-sensitive layer. Alternatively, the touch-sensitive input area may comprise two or more acoustic transducers placed along the horizontal and vertical axes of the display. An example of a computing device implementing aspects of the present disclosure will be discussed in more detail below in conjunction with FIG. 4.

In certain implementations, computing device 100 is equipped with touch screen input device 170 capable of recognizing multiple simultaneous (or nearly simultaneous) tactile contacts with the input surface. Computing device 100 may, responsive to detecting one or more simultaneous or nearly simultaneous contacts of the touch-sensitive surface by an external object, determine the positions of the contacts, the number of the contacts, the change of the positions relatively to the previous positions, and/or manner of contacts (e.g., whether the external object is moving while keeping the contact with the touch-sensitive surface). The external object employed for contacting the touch screen may be represented, for example, by one or more user's fingers, a stylus, or by any other suitable device. Based on the detected touch/release events, the determined positions of the contact, the change of the contact positions, and/or the manner of the contact, the computing device 100 may recognize one or more user input gesture types, including, for example, tapping, double tapping, pressing, swiping, and/or rotating the touch screen.

In certain implementations, memory 130 may store instructions of an application 190 for processing the multi-touch input to select a displayed option. Application 190 may process multi-touch user input for verification of texts produced by OCR or ICR software. In an illustrative example, application 190 may present, on display 135, a character string produced by OCR or ICR software, may visually highlight a portion of the character string, and may prompt the user to provide input verifying the highlighted portion of the character string. Application 190 may assist the user with providing input by presenting, on display 135, different substrings as possible matches for the highlighted portion of the character string. In addition, application 190 may present, on display 135, graphical representations of several multi-touch gestures, with each graphical representation being visually associated with a specific substring from the different substrings presented on display 135. Each multi-touch gesture may correspond to a distinct number of touch contacts via touch screen input device 170. For example, a distinct number of touch contacts may be the number of fingers that the user is using when providing input via touch screen input device 170. In one implementation, application 190 maintains a data structure (e.g., a table) that stores various options for multi-touch contacts and associates each option with a respective display position for presenting a possible substring match for a currently highlighted portion of a character string being processed.

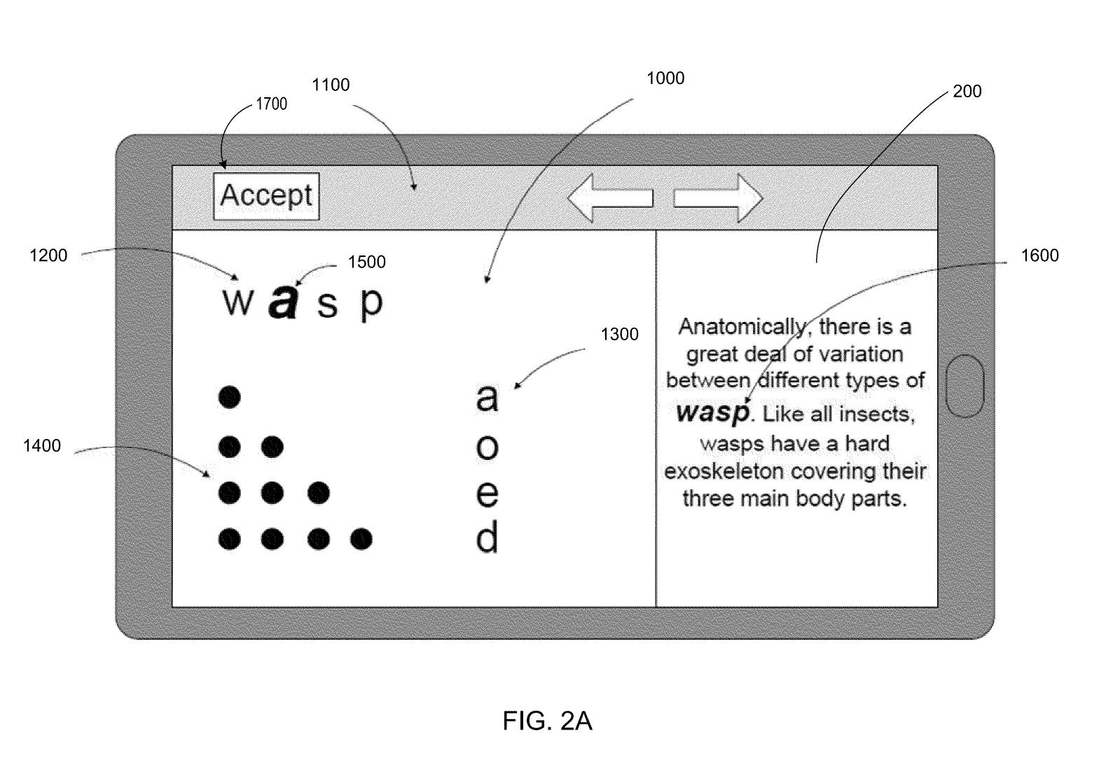

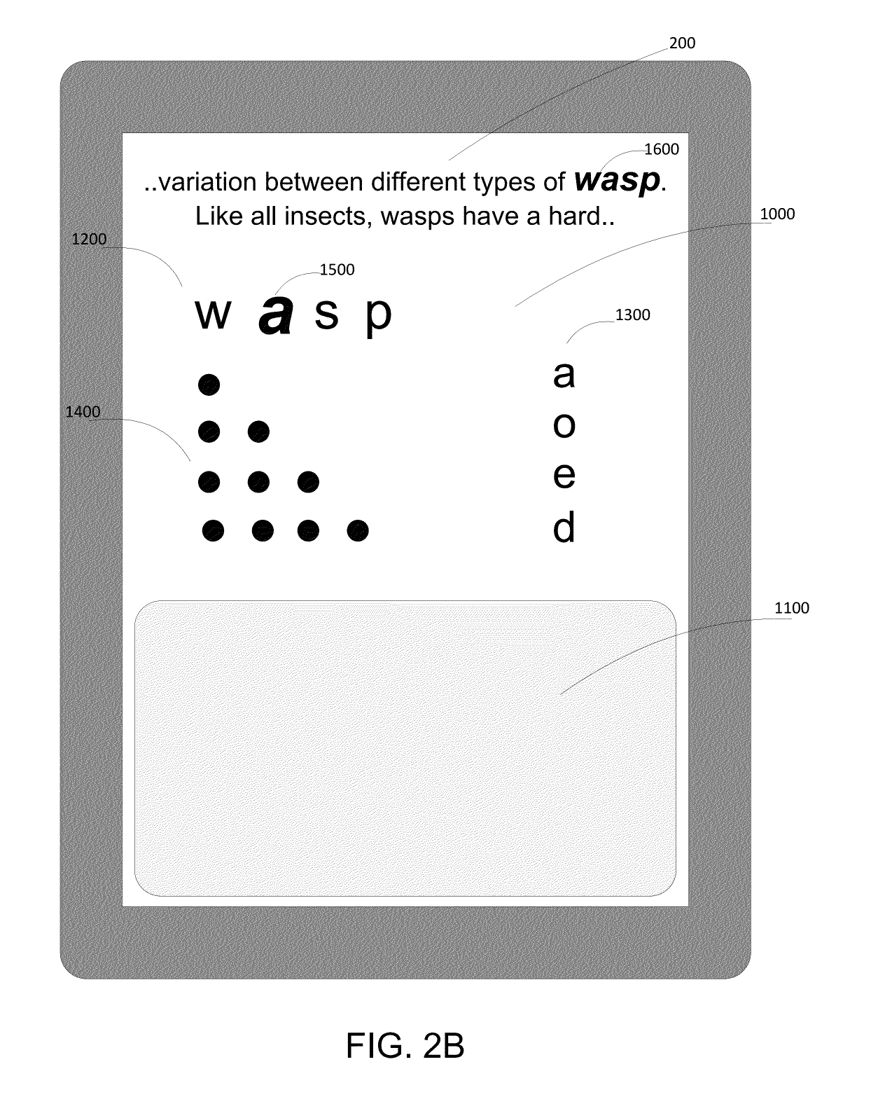

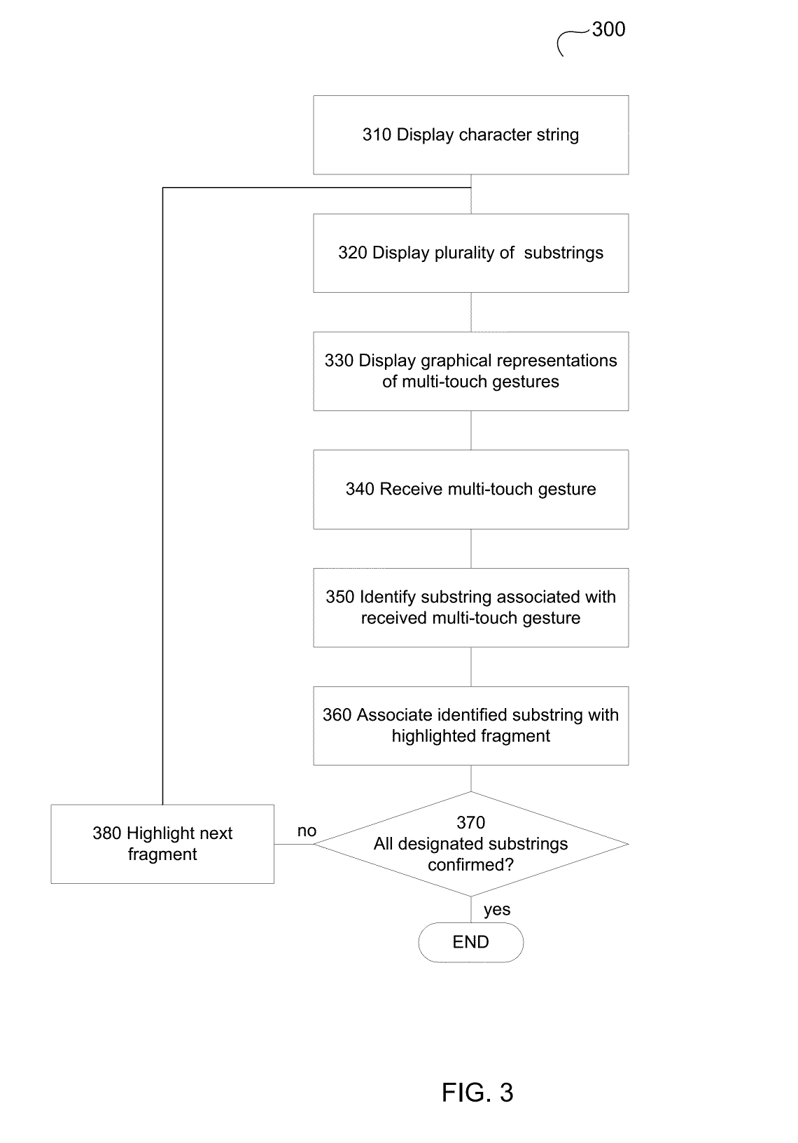

When the user provides input using a certain multi-touch gesture, touch screen input device 170 may identify the number of touch contacts associated with the multi-touch gesture of the user, and may signal this number to application 190. Based on this number, application 190 can determine (e.g., using the above table) the substring match for the currently highlighted portion of the character string, and can replace the currently highlighted portion with the substring match if they are different or can keep the highlighted portion as is if they are the same. Functionality of application 190 and computing device 100 will be discussed in more detail below in conjunction with FIGS. 2 and 3.

FIGS. 2A-2B schematically illustrate examples of the user interface presented by a touch-sensitive display of the computing device 100 of FIG. 1, in accordance with one or more aspects of the present disclosure. Referring to FIG. 2A, the user interface presented on display 135 may include several functional zones, which may be loosely or rigidly defined. The functional zones may include, for example, informational zone 1000 and input zone 1100. Computing device 100 may be programmed to display, in informational zone 1000, character string 1200 to be verified by the operator. Character string 1200 may be visually accompanied by multiple alternative options 1300 of representing character string 1200 or its highlighted fragment 1500.

Character string 1200 may comprise one or more characters and may represent one or more morphemes (e.g., words) of a natural language. Each displayed option 1300 of representing character string 1200 or its highlighted fragment 1500 may be provided as a substring comprising one or more characters of a pre-defined alphabet (e.g., an alphabet corresponding to the alphabet of the natural language to which the morpheme represented by character string 1200 belongs).

One or more characters 1500 of characters string 1200 may be visually distinguished (e.g., highlighted) to indicate the fragment of character string 1200 for which the operator is prompted to choose its representation by one of the displayed options 1300. In various illustrative examples, highlighted fragment 1500 of character string 1200 may be displayed using a typeface, font size, font weight, font slope, and/or color which are different from the remaining characters of character string 1200.

In certain implementations, one or more alternative options 1300 of representing character string 1200 or its highlighted fragment 1500 may be produced by an OCR or ICR application processing character string 1200. Alternatively, one or more other options 1300 may be produced by various other applications or systems (e.g., voice recognition software).

In certain implementations, computing device 100 may further display, in informational zone 1000, the original text comprising character string 1200, in order to provide the context associated with the morpheme represented by character string 1200 in the original text. For example, informational zone 1000 may include area 200 that presents the original text comprising character string 1200. When displayed within the original text in area 200, character string 1200 can be represented as highlighted portion 1600 to illustrate which string of the original text is being currently handled. In various illustrative examples, highlighted portion 1600 of the original text may be displayed using a typeface, font size, font weight, font slope, and/or color which are different from the remaining portions of the original text presented in area 200.

FIG. 2B illustrates another example of the user interface presented by a touch-sensitive display of the computing device 100 of FIG. 1, in accordance with one or more aspects of the present disclosure. Referring to FIG. 2B, the user interface presented on display 135 includes informational zone 1000, which in turn includes input zone 1100 dedicated to receive user input. Input zone 1100 can occupy a predefined portion of the touch-sensitive display of the computing device 100. Similarly to the user interface described above in conjunction with FIG. 2A, computing device 100 may be programmed to display, in informational zone 1000, character string 1200 to be verified by the operator. Character string 1200 may be visually accompanied by multiple alternative options 1300 of representing character string 1200 or its highlighted fragment 1500. One or more characters 1500 of characters string 1200 may be visually distinguished (e.g., highlighted) to indicate the fragment of character string 1200 for which the operator is prompted to choose its representation by one of the displayed options 1300.

As shown in FIG. 2B, computing device 100 may further display, in informational zone 1000, the original text comprising character string 1200. For example, informational zone 1000 may include area 200 that presents the original text comprising character string 1200. When displayed within the original text in area 200, character string 1200 can be represented as highlighted portion 1600 to illustrate which string of the original text is being currently handled.

Referring to FIGS. 2A and 2B, in certain implementations, the first displayed option 1300 may coincide with highlighted fragment 1500 of character string 1200 and may represent the primary option suggested by the application or system that has processed character string 1200 (e.g., an OCR or ICR application). Alternatively, multiple options 1300 may be displayed in an arbitrary order.

Computing device 100 may further display, in informational zone 1000, graphical representations of multi-touch gestures corresponding to alternative options 1300. Each of displayed alternative options 1300 may be visually associated with a graphical representation of a multi-touch gesture that the user is required to perform in order to select the corresponding option.

In certain implementations, each gesture may be represented by a multi-touch contact involving the number of operator's fingers being equal to the ordinal number (displayed or implicit) of the display position of a particular displayed option. In the illustrative examples of FIGS. 2A and 2B, to select the option number one (letter a), a single-touch contact with a pre-defined input area of the touch screen may be required; to select the option number two (letter o), a two-finger contact with the input area of the touch screen may be required; and so on. Hence, for each displayed option, a visually associated graphical representation of a multi-touch gesture may instruct the operator on the number of tactile contact points required to select the option.

In certain implementations, the graphical representations of the multi-touch gestures may comprise a repetitive graphical element (e.g., an asterisk, a symbolic image of a fingerprint, or a circle, as shown in the illustrative examples of FIGS. 2A and 2B) in which the number of instances of the graphical element corresponds to the number of tactile contact points required to select the corresponding option.

Computing device 100 may receive, via touch-screen input device 170, a multi-touch gesture performed by the operator in response to being prompted to select one of the displayed options 1300. In certain implementations, the operator may be prompted and/or instructed to perform the multi-touch gesture within the designated input area 1100, which is part of informational zone 1000, as schematically illustrated by FIG. 2B.

Alternatively, as schematically illustrated by FIG. 2A, designated input area 1100 may be a separate area from the informational zone 1000 and may be intended to accept secondary confirmation (via a dedicated button) and navigation inputs, while the multi-touch gesture indicating the operator's selection of one of the displayed options 1300 may be performed by the operator anywhere within the screen of computing device 100.

Hence, to select one of the displayed alternative options, the operator may only be required to perform finger movements, while keeping the arm and shoulder stationary. Thus, the physical strain onto the operator's hand, arm and/or shoulder may be significantly reduced as compared to various conventional applications. As a result, the operator's productivity can be improved.

Responsive to receiving the multi-touch gesture performed by the operator, computing device 100 may identify the option selected by the operator based on the number of touch contacts comprised by the multi-touch gesture. As discussed above, the option selected by the operator can be represented by the option having the ordinal position on the display, relative to positions of other displayed options.

In certain implementations, computing device 100 may, responsive to receiving the multi-touch gesture performed by the operator, prompt the operator to confirm the selection and/or accept, without explicitly prompting, the touch screen input indicating the selection. In an illustrative example, computing device 100 may highlight the option selected by the operator and prompt the operator to tap on the input area for the second time to confirm the selection. In another illustrative example, the operator may confirm the selection by tapping on an image of a pre-defined user interface control (e.g., “Accept” button 1700). In another illustrative example, computing device 100 may substitute highlighted fragment 1500 of character string 1200 with the substring selected by the operator and prompt the operator to confirm the selection by tapping the screen within the input area.

In certain implementations, responsive to receiving the operator's selection or confirmation, computing device 100 may highlight the next fragment of character string 1200, display a new list of options corresponding to the newly highlighted fragment, thus prompting the operator to select an option corresponding to the newly highlighted fragment of character string 1200. The process may continue until all substrings of character string 1200 that need to be verified would have been confirmed by the operator. In an illustrative example, computing device may present to the operator for verification only those substrings of character string 1200 which have been designated for the operator verification by the OCR software that produced character string 1200.

FIG. 3 depicts a flow diagram of one illustrative example of a method 300 for processing multi-touch input to select a displayed option, in accordance with one or more aspects of the present disclosure. Method 300 and/or each of its individual functions, routines, subroutines, or operations may be performed by one or more processors of the computer device (e.g., computing device 100 of FIG. 1) executing the method. In certain implementations, method 300 may be performed by a single processing thread. Alternatively, method 300 may be performed by two or more processing threads, each thread executing one or more individual functions, routines, subroutines, or operations of the method. In an illustrative example, the processing threads implementing method 300 may be synchronized (e.g., using semaphores, critical sections, and/or other thread synchronization mechanisms). Alternatively, the processing threads implementing method 300 may be executed asynchronously with respect to each other.

At block 310, the computing device performing the method may present, on a display equipped with a multi-touch input surface, a character string.

At block 320, the computing device may display a plurality of operator-selectable options represented by substrings (e.g., produced by OCR or ICR software) corresponding to a highlighted fragment (e.g., one or more characters) of the displayed character string.

At block 330, the computing device may display graphical representations of a plurality of multi-touch gestures, such that each graphical representation is associated with a substring of the plurality of substrings, as described in more details herein above with references to FIG. 2.

At block 340, the computing device may receive, via the multi-touch input surface, a multi-touch gesture comprising one or more touch contacts with the touch-sensitive input surface.

At block 350, the computing device may identify a substring that is visually associated with the graphical representation of the received multi-touch gesture. In certain implementations, the substring may be identified as one having the ordinal position on the display, relative to positions of other substrings, that corresponds to the number of touch contacts comprised by the multi-touch gesture. As discussed above, according to some implementations, the substring may be identified using a data structure (e.g., a table) that stores various options for a multi-touch gesture in association with respective ordinal display positions for presenting possible substring matches.

At block 360, the computing device may associate the identified substring with at least part of the original character string corresponding to the highlighted fragment of the original character string.

Responsive to ascertaining, at block 370, that all substrings of character string 1200 that need to be verified have been confirmed by the operator, the method may terminate; otherwise, at block 380, the computing device may highlight the next fragment of the original character string that needs to be verified by the operator and loop back to block 320. In an illustrative example, computing device may present to the operator for verification only those substrings of the original character string which have been designated for the operator verification by the OCR software that produced the original character string.

While in the foregoing examples the systems and methods are employed for processing multi-touch input for verification of texts produced by OCR or ICR software, in various other implementations the systems and methods described herein may be employed for processing user input for various other application.

FIG. 4 illustrates a more detailed diagram of an example computing device 500 within which a set of instructions, for causing the computing device to perform any one or more of the methods discussed herein, may be executed. The computing device 500 may include the same components as computing device 100 of FIG. 1, as well as some additional or different components, some of which may be optional and not necessary to provide aspects of the present disclosure. The computing device may be connected to other computing device in a LAN, an intranet, an extranet, or the Internet. The computing device may operate in the capacity of a server or a client computing device in client-server network environment, or as a peer computing device in a peer-to-peer (or distributed) network environment. The computing device may be a provided by a personal computer (PC), a tablet PC, a set-top box (STB), a Personal Digital Assistant (PDA), a cellular telephone, or any computing device capable of executing a set of instructions (sequential or otherwise) that specify operations to be performed by that computing device. Further, while only a single computing device is illustrated, the term “computing device” shall also be taken to include any collection of computing devices that individually or jointly execute a set (or multiple sets) of instructions to perform any one or more of the methodologies discussed herein.

Exemplary computing device 500 includes a processing device (processor) 502, a main memory 504 (e.g., read-only memory (ROM) or dynamic random access memory (DRAM)), and a data storage device 518, which communicate with each other via a bus 530.

Processor 502 may be represented by one or more general-purpose processing devices such as a microprocessor, central processing unit, or the like. More particularly, processor 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 502 may also be one or more special-purpose processing devices such as an application specific integrated circuit (ASIC), a field programmable gate array (FPGA), a digital signal processor (DSP), network processor, or the like. Processor 502 is configured to execute instructions 526 for performing the operations and functions discussed herein.

Computing device 500 may further include a network interface device 522, a video display unit 510, an alphanumeric input device 512 (e.g., a keyboard), and a touch screen input device 514.

Data storage device 518 may include a computer-readable storage medium 524 on which is stored one or more sets of instructions 526 embodying any one or more of the methodologies or functions described herein. Instructions 526 may also reside, completely or at least partially, within main memory 504 and/or within processor 502 during execution thereof by computing device 500, main memory 504 and processor 502 also constituting computer-readable storage media. Instructions 526 may further be transmitted or received over network 516 via network interface device 522.

In certain implementations, instructions 526 may include instructions for a method of processing multi-touch input to select a displayed option, which may correspond to method 300, and may be performed by application 190 of FIG. 1. While computer-readable storage medium 524 is shown in the example of FIG. 4 to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and software components, or only in software.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining”, “computing”, “calculating”, “obtaining”, “identifying,” “modifying” or the like, refer to the actions and processes of a computing device, or similar electronic computing device, that manipulates and transforms data represented as physical (e.g., electronic) quantities within the computing device's registers and memories into other data similarly represented as physical quantities within the computing device memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Various other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
presenting, on a display of a computing device, a plurality of alternative options pertaining to digital content;
receiving, via a touch-sensitive input area of the display, a multi-touch gesture comprising one or more touch contacts with the touch-sensitive input area; and
identifying an option having an ordinal position on the display, relative to positions of other alternative options, that corresponds to a number of touch contacts comprised by the received multi-touch gesture.

2. The method of claim 1, further comprising:
presenting, on the display, a plurality of graphical representations of multi-touch gestures visually associated with the plurality of alternative options.

3. The method of claim 1, wherein the digital content comprises text, and each of the plurality of alternative options is provided by a substring pertaining to at least part of a character string presented on the display.

4. The method of claim 3, further comprising:
associating, with at least part of the character string, a substring corresponding to the identified option.

5. The method of claim 3, wherein the character string represents a morpheme of a natural language.

6. The method of claim 5, wherein each substring comprises one or more characters of a pre-defined alphabet.

7. The method of claim 1, wherein the multi-touch gesture comprises two or more simultaneous touch contacts with the touch-sensitive input area.

8. A computing device comprising:
a memory;
a display; and
a processor, coupled to the memory, to:
present, on a display of a computing device, a plurality of alternative options pertaining to digital content;
receive, via a touch-sensitive input area of the display, a multi-touch gesture comprising one or more touch contacts with the touch-sensitive input area; and
identify an option having an ordinal position on the display, relative to positions of other alternative options, that corresponds to a number of touch contacts comprised by the received multi-touch gesture.

9. The system of claim 8, wherein the processor is further to:
present, on the display, a plurality of graphical representations of multi-touch gestures visually associated with the plurality of alternative options.

10. The system of claim 8, wherein the content comprises text, and each of the plurality of alternative options is provided by a substring pertaining to at least part of a character string presented on the display.

11. The system of claim 10, further comprising:
associating, with at least part of the character string, a substring corresponding to the identified option.

12. The system of claim 10, wherein the touch-sensitive input area comprises at least part of a surface of the display.

13. A computer-implemented method comprising:
presenting, on a display, a character string;
presenting, on the display, a plurality of substrings pertaining to at least part of the character string;
presenting, on the display, graphical representations of a plurality of multi-touch gestures, each graphical representation being visually associated with a respective substring of the plurality of substrings;
receiving, via a touch-sensitive input area of the display, a multi-touch gesture of the plurality of multi-touch gestures, the multi-touch gesture comprising one or more touch contacts with the touch-sensitive input area; and
identifying a substring that is visually associated with a graphical representation of the received multi-touch gesture.

14. The method of claim 13, wherein the substring has an ordinal position on the display, relative to positions of other substrings, that corresponds to a number of touch contacts comprised by the multi-touch gesture.

15. The method of claim 13, further comprising:
associating the identified substring with the at least part of the character string.

16. The method of claim 13, wherein the multi-touch gesture comprises two or more simultaneous touch contacts with the touch-sensitive input area.

17. A computer-readable non-transitory storage medium comprising executable instructions that, when executed by a computing device, cause the computing device to perform operations comprising:
presenting, on a display, a character string;
presenting, on the display, a plurality of substrings pertaining to at least part of the character string;
presenting, on the display, graphical representations of a plurality of multi-touch gestures, each graphical representation being visually associated with a respective substring of the plurality of substrings;
receiving, via a touch-sensitive input area of the display, a multi-touch gesture of the plurality of multi-touch gestures, the multi-touch gesture comprising one or more touch contacts with the touch-sensitive input area; and
identifying a substring that is visually associated with a graphical representation of the received multi-touch gesture.

18. The computer-readable non-transitory storage medium of claim 17, wherein the substring has an ordinal position on the display, relative to positions of other substrings, that corresponds to a number of touch contacts comprised by the multi-touch gesture.

19. The computer-readable non-transitory storage medium of claim 17, wherein the operations further comprise:
associating the identified substring with the at least part of the character string.

20. The computer-readable non-transitory storage medium of claim 17, wherein the character string represents a morpheme of a natural language.

21. The computer-readable non-transitory storage medium of claim 17, wherein each substring comprises one or more characters of a pre-defined alphabet.

22. The computer-readable non-transitory storage medium of claim 17, wherein the multi-touch gesture comprises two or more simultaneous touch contacts with the touch-sensitive input area.

23. The computer-readable non-transitory storage medium of claim 17, wherein the touch-sensitive input area occupies a predefined portion of the display.
